(19) United States
(12) Patent Application Publication
(10) Pub. No.: US 2026/0037277 A1
(43) Pub. Date: Feb. 5, 2026

(54) Verifying Assignment Of Initial Values To Instance Fields Of Class Instances

(71) Applicant: Oracle International Corporation, Redwood Shores, CA (US)

(72) Inventors: Daniel Lee Smith, Spanish Fork, UT (US); John Robert Rose, San Jose, CA (US); Brian Goetz, Williston, VT (US); Frederic Sylvain Parain, Acton, MA (US); Daniel J. Heidinga, Ottawa (CA)

(73) Assignee: Oracle International Corporation, Redwood Shores, CA (US)

(21) Appl. No.: 19/198,936

(22) Filed: May 5, 2025

Related U.S. Application Data
(60) Provisional application No. 63/677,906, filed on Jul. 31, 2024.
(60) Provisional application No. 63/677,907, filed on Jul. 31, 2024.
(60) Provisional application No. 63/677,909, filed on Jul. 31, 2024.

(51) Int. Cl. G06F 9/445; G06F 9/54

(52) U.S. Cl. CPC G06F 9/44521; G06F 9/547

(57) ABSTRACT

A system encounters an instruction that triggers generating an array that includes a set of elements initialized with a set of initial values. In response to encountering the instruction, the system identifies an application programming interface (API) for generating the array and executes a call to the API to request the API to generate the array. The API receives the call and, in response to the call, executes an array generation process to generate the array. The API provides the array to the system, and the system receives the array from the API. The array includes the set of elements initialized with the set of initial values.

### INCORPORATION BY REFERENCE; DISCLAIMER

This application claims the benefit of U.S. Provisional Patent Application Nos. 63/677,906, 63/677,907, and 63/677,909, filed Jul. 31, 2024, which are hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to computer programming. More particularly, the present disclosure relates to object-oriented computer programming.

### BACKGROUND

Computing environments, such as object-oriented computing environments, utilize classes as a blueprint for creating objects. A class defines a type by specifying fields and behaviors that apply to instances of that class (i.e., runtime objects). A field is a variable that is declared within a class. A field may hold data that represents a state, or part of a state, of an object. A class can include multiple fields, including one or more instance fields and/or one or more static fields. An instance field is a field that is specific to a particular instance of a class. A static field is a field that is shared among instances of a class. Fields of a class can be accessed and utilized by various elements in the computing environment, such as methods, constructors, and other classes.

Additionally, computing environments, such as object-oriented computing environments, utilize arrays as data structures to store and manage collections of elements. An array is an object that holds multiple elements. The elements can be accessed using an index. For example, the first element of an array may be accessed at index 0; the second element of an array may be accessed at index 1; etc. Arrays may be utilized in a computing environment to provide constant-time access to elements based on their respective indexes. Arrays may be utilized in a variety of ways in a computing environment. An array may serve as a field within a class, for example, to maintain collections of related data. As another example, an array may be utilized as an argument for a method. Additionally or alternatively, a method may generate an array as a return type.

The content of this background section should not be construed as prior art merely by virtue of its presence in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced.

FIG. 2 is a block diagram illustrating one embodiment of a computer system suitable for implementing methods and features described herein.

FIG. 3 illustrates an example virtual machine memory layout in block diagram form according to an embodiment.

FIG. 4 illustrates an example frame in block diagram form according to an embodiment.

FIG. 5 is a block diagram that illustrates an example of a system according to one or more embodiments;

FIGS. 6A-6D illustrate an example set of operations for verifying assignment of initial values to instance fields of a class instance according to one or more embodiments;

FIGS. 7A-7C illustrate an example set of operations for verifying assignment of initial values to static fields of a class according to one or more embodiments;

FIGS. 8A-8D illustrate an example set of operations for generating arrays that are initialized with initial values in accordance with one or more embodiments; and

FIG. 9 is a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DEFINITIONS
3. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
4. EXAMPLE COMPUTING SYSTEM
5. EXAMPLE OPERATIONS FOR VERIFYING ASSIGNMENT OF INITIAL VALUES TO INSTANCE FIELDS OF A CLASS INSTANCE
6. EXAMPLE OPERATIONS FOR VERIFYING ASSIGNMENT OF INITIAL VALUES TO STATIC FIELDS OF A CLASS
7. EXAMPLE OPERATIONS FOR GENERATING ARRAYS THAT ARE INITIALIZED WITH INITIAL VALUES
8. HARDWARE OVERVIEW
9. MISCELLANEOUS; EXTENSIONS

### 1. General Overview

One or more embodiments assure that elements are initialized with initial values before the elements are accessed in a runtime environment. A system executes a verification process to verify that an element is initialized with an initial value. When the system determines that an element is initialized with an initial value, the system allows the element to be accessed in the runtime environment. Additionally or alternatively, when the system determines that an element is not initialized with an initial value, the system initiates an error handling process. The error handling process refrains from allowing the element to be accessed in the runtime environment, at least until the element is initialized with an initial value.

In one example, the system verifies that instance fields of class instances are assigned initial values before the instance fields are accessed in the runtime environment. In response to an instruction that triggers loading a class, the system performs a bytecode verification. The bytecode verification verifies that when an object representing an instance of the class is instantiated, instance fields of the object are assigned initial values at least prior to the object being accessible in the runtime environment. The bytecode verification is a static analysis performed prior to loading the class in the runtime environment. The bytecode verification identifies an object instantiation process (for example, a constructor) that is executable to instantiate an object. The bytecode verification further determines whether the object instantiation process, when executed, assigns an initial value to one or more instance fields of the object at least prior to the object being accessible in the runtime environment. Loading the class in the runtime environment is contingent upon the system determining that the object instantiation process, when executed, assigns an initial value to the one or more instance fields of the object at least prior to the object being accessible in the runtime environment. The system loads the class in the runtime environment in response to determining that the object instantiation process, when executed, assigns an initial value to the one or more instance fields of the object at least prior to the object being accessible in the runtime environment. Additionally or alternatively, the system initiates execution of an error handling process in response to determining that the object instantiation process, when executed, does not assign an initial value to one or more instance fields of the object prior to the object being accessible in the runtime environment. The error handling process may refrain from loading the class in the runtime environment. In one example, the error handling process refrains from loading the class until the system determines in a subsequent bytecode verification that the object instantiation process, when executed, assigns an initial value to the one or more instance fields of the object at least prior to the object being accessible in the runtime environment.

In one example, the system verifies that static fields of a class are assigned initial values before the static fields are accessed in the runtime environment. In response to a static field access instruction, the system performs a dynamic analysis to verify that the static field has been assigned an initial value. The dynamic analysis may be performed on the first instance of an instruction to access the static field. Access to the static field is contingent upon the system determining that an initial value has been assigned to the static field. In response to determining that an initial value has been assigned to the static field, the system accesses the static field. Additionally or alternatively, in response to determining that an initial value has not been assigned to the static field, the system initiates execution of an error handling process. In one example, the error handling process refrains from accessing the static field, for example, at least until the system determines in a subsequent analysis that an initial value has been assigned to the static field.

In one example, the system generates arrays that are initialized with initial values. Additionally or alternatively, the system verifies that arrays are initialized with initial values before the arrays are accessed in the runtime environment. The system generates arrays for use in the runtime environment by calling an application programming interface (API) that generates arrays in accordance with a constraint requiring that elements of the array be initialized with initial values. In response to an instruction that triggers generating an array, the system identifies an API for generating the array and executes a call to the API to request the API to generate the array. The API receives the call and, in response to the call, executes an array generation process to generate the array. The API provides the array with the set of elements initialized with the set of initial values. In one example, prior to providing the array, the API executes a verification process to verify that the set of elements are initialized with the set of initial values. The verification process may verify that the elements of the array contain the initial values. Additionally or alternatively, subsequent to receiving the array from the API, the system executes a verification process to verify that the set of elements are initialized with the set of initial values prior to utilizing the array in the runtime environment.

By assuring that elements are initialized with initial values before being accessed, the system prevents exposure to uninitialized memory and mitigates associated risks, such as the possibility of runtime errors, unpredictable computations, and/or erroneous return values. Thus, one or more embodiments enhance data integrity as well as the stability and security of the runtime environment.

When fields are not explicitly initialized with initial values, the system may automatically set default values based on their type. For example, the system may set numeric fields to a default value of “0” (zero), Boolean fields to a default value of “false,” and/or object references to a default value of “null.” If fields of an element are intended to store specific values but are left uninitialized, undefined behavior may occur when the fields of the element are accessed, such as runtime errors, unpredictable computations, and/or erroneous return values.

Additionally, some fields do not have an appropriate default value that can be set when the fields are not explicitly initialized with initial values. Fields that are initialized without an initial value and that do not have an appropriate default value give rise to a risk of accessing uninitialized memory, which may cause problems such as memory corruption, undefined behavior, and/or security vulnerabilities. One example of fields that do not have an appropriate default value are fields of complex object types (e.g., instances of user-defined classes). If a field represents a configuration object or a database connection, initializing the field to “null” or to a default placeholder may be impractical, unstable, or incompatible with security protocols. As another example, fields that represent critical or mandatory information (e.g., an object that is initialized with user data or a specific configuration) often do not have a meaningful default value because a default value might be nonsensical in the context of the application. Further, immutable fields that cannot be modified after being initialized may be invalid if initialized with a default value. Immutable fields are intended to be set once and never changed. Examples of immutable fields according to an embodiment include personal information (e.g., social security number, date of birth, employee ID number, etc.) that remains constant for a particular individual, geographical coordinates of a fixed location, fleet information for a predefined fleet whose composition does not change, or product information. Additionally or alternatively, immutable fields may include constants, immutable strings, configuration settings, or conversion factors. As yet another example, fields that depend on external resources, such as databases, configuration files, or user input, often do not have appropriate default values. Further, fields that represent optional or nullable values often do not have a meaningful default value because the absence of a value is a valid state.

One or more embodiments described in this Specification and/or recited in the claims may not be included in this General Overview section.

### 2. Definitions

As used herein, the term “object instantiation process” refers to a process for instantiating an object. An object instantiation process may include one or more code segments that, when executed, instantiate the object. The sequence of operations that are executed in an object instantiation process may include one or more of the following: memory allocation, field initialization, execution of initializers, or constructor invocation.

As used herein, the term “constructor” refers to a method that is invoked as part of an object instantiation process to perform object-specific operations for initializing an object. For example, a constructor may load classes, set initial values, enforce constraints, and/or perform other object-specific operations.

As used herein, the term “constructor invocation point” refers to an operation within an object instantiation process that calls a constructor to commence executing operations for initializing an object.

As used herein, the term “field initialization process” refers to a sequence of operations that are executed as part of an object instantiation process to assign values to fields. A field initialization process may assign a value to an instance field of an object. The value assigned by the field initialization process may include a default value or an initial value.

As used herein, the term “reference-passing operation” refers to an operation that, when executed, passes an object reference (i.e., a variable that holds the memory address of a particular object) to another component executing a runtime environment. A reference-passing operation may pass a reference as an argument to a method. Additionally or alternatively, a reference-passing operation may assign a reference to a variable.

As used herein, a “component” executing in a runtime environment is a unit of code that can be actively run or invoked as part of an operation executed in the runtime environment. For example, a component executing in a runtime environment may include one or more of the following: an initialization method, an event listener, a callback, a thread, a constructor, or a superclass constructor.

As used herein, the term “class initialization process” refers to a process for initializing a class. A class initialization process may include one or more of the following: loading bytecode into memory, linking the class, or initializing static fields. Linking may include one or more of the following: bytecode verification, memory allocation for static fields, or resolution of symbolic references.

### 3. Architectural Overview

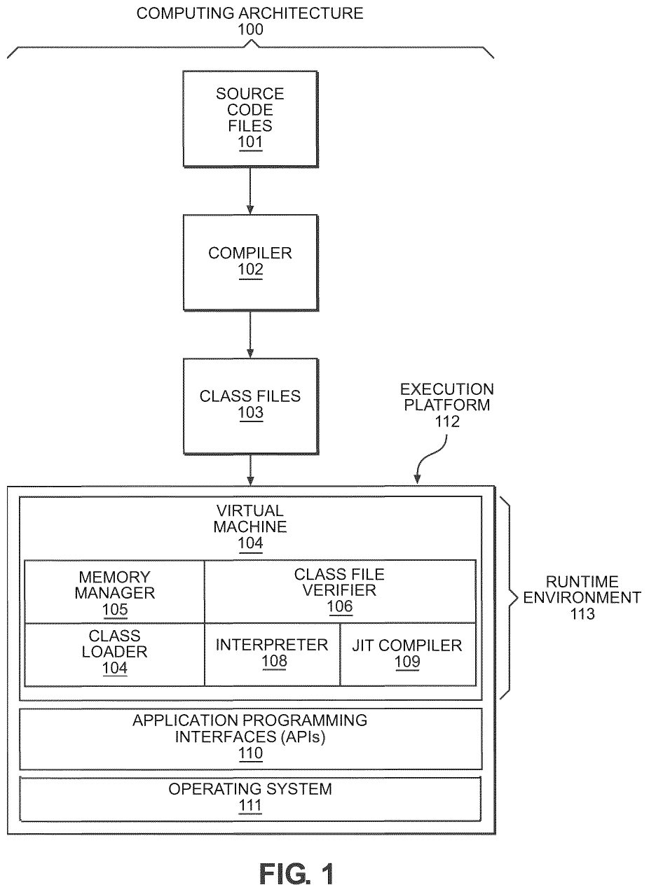

FIG. 1 illustrates an example architecture according one or more embodiments. Software and/or hardware components described with relation to the example architecture may be omitted or associated with a different set of functionalities than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 that are compiled by a compiler 102 into class files 103 representing the program to be executed. The class files 103 are then loaded and executed by an execution platform 112. The execution platform 112 includes a runtime environment 113, an operating system 111, and one or more APIs 110 that enable communication between the runtime environment 113 and the operating system 111. The runtime environment 113 includes a virtual machine 104 that includes various components, such as a memory manager 105, a class file verifier 106, a class loader 107, an interpreter 108, and a just-in-time (JIT) compiler 109. The memory manager 105 may include a garbage collector. The garbage collector may execute garbage collection operations. The class file verifier 106 may check the validity of class files 103. The class loader 107 may locate and build in-memory representations of classes. The interpreter 108 may execute the virtual machine 104 code. The JIT compiler 109 may producing optimized machine-level code.

In an embodiment, the computing architecture 100 includes source code files 101 that contain code that has been written in a particular programming language, such as Java, C, C++, C#, Ruby, Perl, and so forth. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification. The exact programming language used to write the source code files 101. Various programming languages may be utilized for various different embodiments.

In various embodiments, the compiler 102 may convert the source code, written according to a specification directed to the convenience of the programmer, to either machine or object code that is executable directly by the particular machine environment. Additionally or alternatively, the compiler 102 may convert the source code to an intermediate representation (“virtual machine code/instructions”) such as bytecode that is executable by a virtual machine 104. The virtual machine 104 may be capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware where the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, and so forth. However, depending on the program being executed, the startup time can be significant. In addition, inserting new code would require the program to be taken offline, re-compiled, and re-executed. For many dynamic languages (such as Java) that are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation on the fly. Furthermore, since each instruction is analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions that replaces the “hot” block of code for future executions. Since programs tend to spend a significant proportion of time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting each instruction individually. There are a number of variations on the above-described example, such as tiered compiling.

To provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format, and the class files 103 are expected to adhere to the particular class file format. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, and so forth).

The following discussion assumes that each of the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages” that respectively include a collection of classes that provide related functionality. For example, a library may contain one or more class files that implement input/output (I/O) operations, mathematics tools, cryptographic techniques, graphics utilities, and so forth. Further, some classes (or fields/methods within those classes) may include access restrictions that limit their use to within a particular class/library/package or to classes with appropriate permissions.

### 3.1 Example Class File Structure

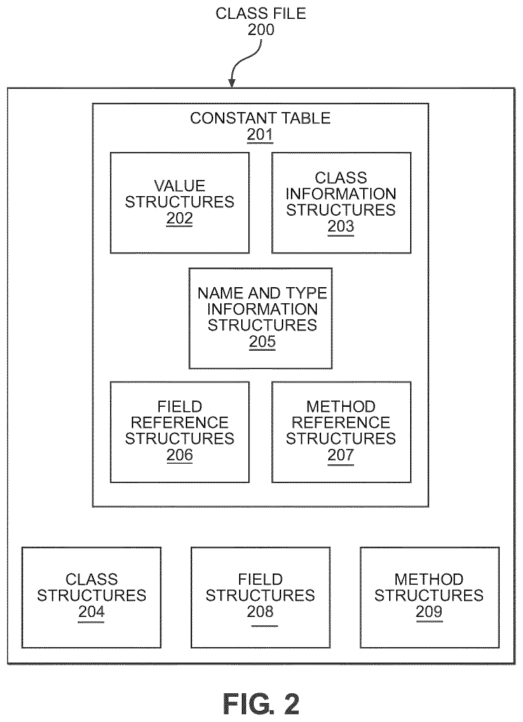

FIG. 2 illustrates an example structure for a class file 200 in block diagram form according to an embodiment. To provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, field structures 208, class metadata 207, and method structures 209. In an embodiment, the constant table 201 is a data structure that, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, and so forth), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures that index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (whether the class is public, private, final, abstract, etc.), an index to one of the class information structures 203 of the constant table 201 that identifies the present class, an index to one of the class information structures 203 of the constant table 201 that identifies the superclass (if any), and so forth.

In an embodiment, the field structures 208 represent a set of structures that identifies the various fields of the class. The field structures 208 store, for each field of the class, accessor flags for the field (whether the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for each method of the class, accessor flags for the method (e.g. whether the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where each index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor “, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations that reference entries of the constant table 201. Using Java as an example, consider the following class:

```
class A
{
  int add12and13( ) {
    return B.addTwo(12, 13);
  }
}
```

In the above example, the Java method add12andl3 is defined in class A, takes no parameters, and returns an integer. The body of method add12 and13 calls static method addTwo of class B. The static method addTwo of class B takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(II) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

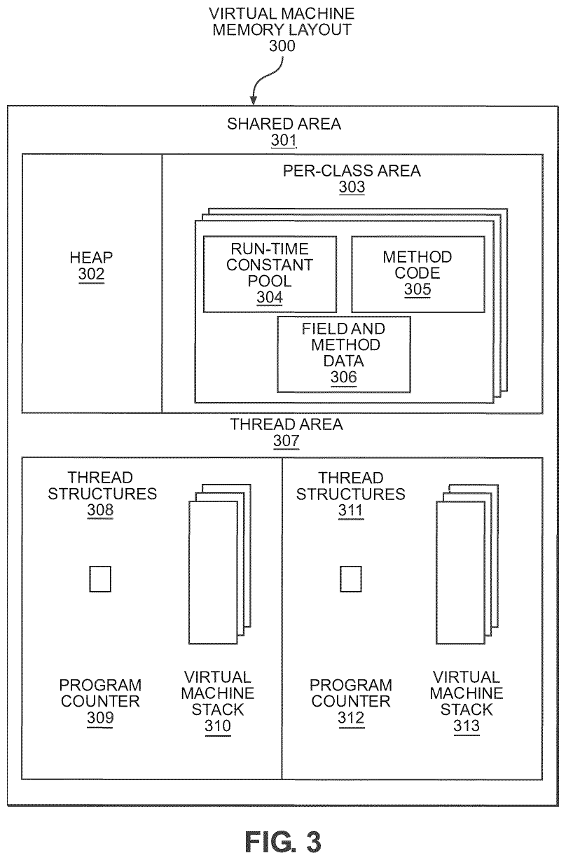

FIG. 3 illustrates an example virtual machine memory layout 300 in block diagram form according to an embodiment. To provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas be contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area where memory for class instances and arrays is allocated. In an embodiment, the per-class area 303 represents the memory area where the data for the individual classes are stored. In an embodiment, the per-class area 303 includes, for each loaded class, a run-time constant pool 304 representing data from the constant table 201 of the class, field, and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. To provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 each store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class that the current method belongs is referred to as the current class.

Referring further to FIG. 3, in one example, the shared area may include the heap 302 and an off-heap memory 314. One or more memory regions may be located within the heap 302. Each memory region located in the heap 302 may include one or more shared memory segments that are accessible by a set of accessing threads. The off-heap memory 314 may include one or more memory regions located outside the heap 302. Each memory region located in the off-heap memory 314 may include one or more shared memory segments that are accessible by a set of accessing threads. In one example, the off-heap memory 314 and/or a memory region located in the off-heap memory 314 may be managed by an application or by a provisioning thread, for example, instead of the JVM. In one example, the off-heap memory 314 and/or a memory region located in the off-heap memory 314 may be utilized for non-managed data structures, such as large buffers, caches, or custom data models. Additionally or alternatively, the off-heap memory 314 and/or a memory region located in the off-heap memory 314 may be utilized for data structures that exceed the capacity of the heap 302 and/or that require more efficient memory handling. Additionally or alternatively, the off-heap memory 314 and/or a memory region located in the off-heap memory 314 may be utilized to provide interaction with native libraries or to provide direct memory access.

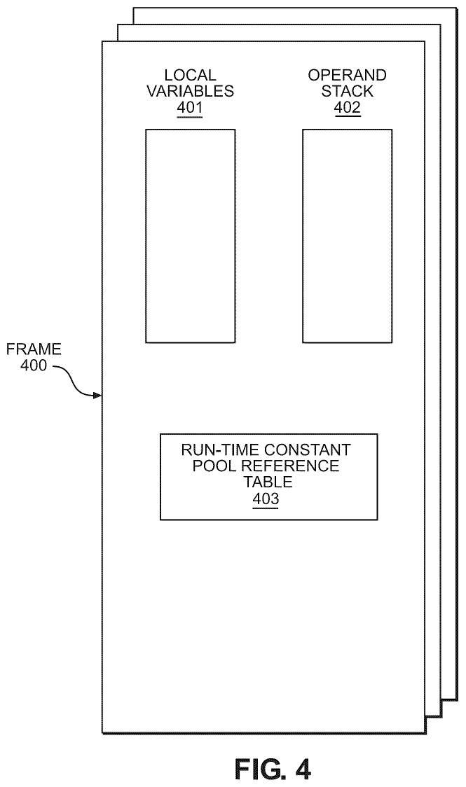

FIG. 4 illustrates an example frame 400 in block diagram form according to an embodiment. To provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, the operand stack 402 is empty by default when the frame 400 is created by the virtual machine 104. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 3.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in some embodiments the steps may be interleaved, such that an initial class is loaded, then during linking a second class is loaded to resolve a symbolic reference found in the first class. The loading of the second class, in turn, causes a third class to be loaded, and so forth. Thus, progress through the stages of loading, linking, and initializing can differ from class to class. Further, some embodiments may delay (perform “lazily”) one or more functions of the loading, linking, and initializing process until the class is actually required. For example, resolution of a method reference may be delayed until a virtual machine instruction invoking the method is executed. Thus, the exact timing of when the steps are performed for each class can vary between implementations.

To begin the loading process, the virtual machine 104 starts up by invoking the class loader 107, and the class loader 107 loads an initial class. The technique whereby the initial class is specified will vary from embodiment to embodiment. For example, one technique may have the virtual machine 104 accept a command line argument on startup that specifies the initial class.

To load a class, the class loader 107 parses the class file 200 corresponding to the class and determines whether the class file 200 is well-formed (meets the syntactic expectations of the virtual machine 104). If not, the class loader 107 generates an error. For example, in Java the error might be generated in the form of an exception that is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking, and initializing process for the particular class.

During loading, the virtual machine 104 verifies the class, prepares the class, and performs resolution of the symbolic references defined in the run-time constant pool 304 of the class.

To verify the class, the virtual machine 104 checks whether the in-memory representation of the class is structurally correct. For example, the virtual machine 104 may check that each class except the generic class Object has a superclass, check that final classes have no sub-classes and final methods are not overridden, check whether constant pool entries are consistent with one another, check whether the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), and so forth. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, and this might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking whether the field/method is defined in the referenced class. Otherwise, the virtual machine 104 recursively searches through the super-classes of the referenced class for the referenced field/method until the field/method is located or until the top-level superclass is reached. If the top-level super class is reached, an error may be generated.

### 4. Example Computing System

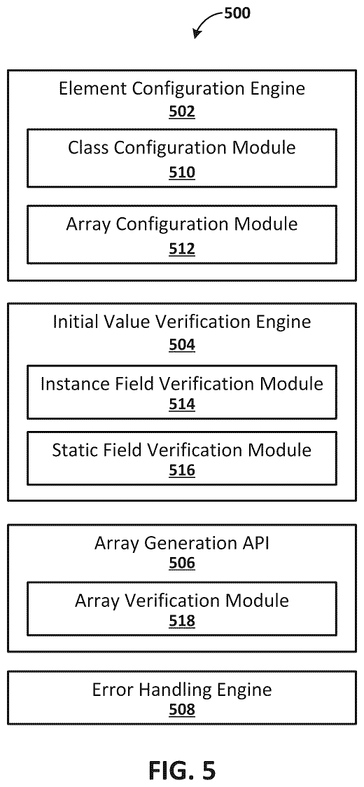

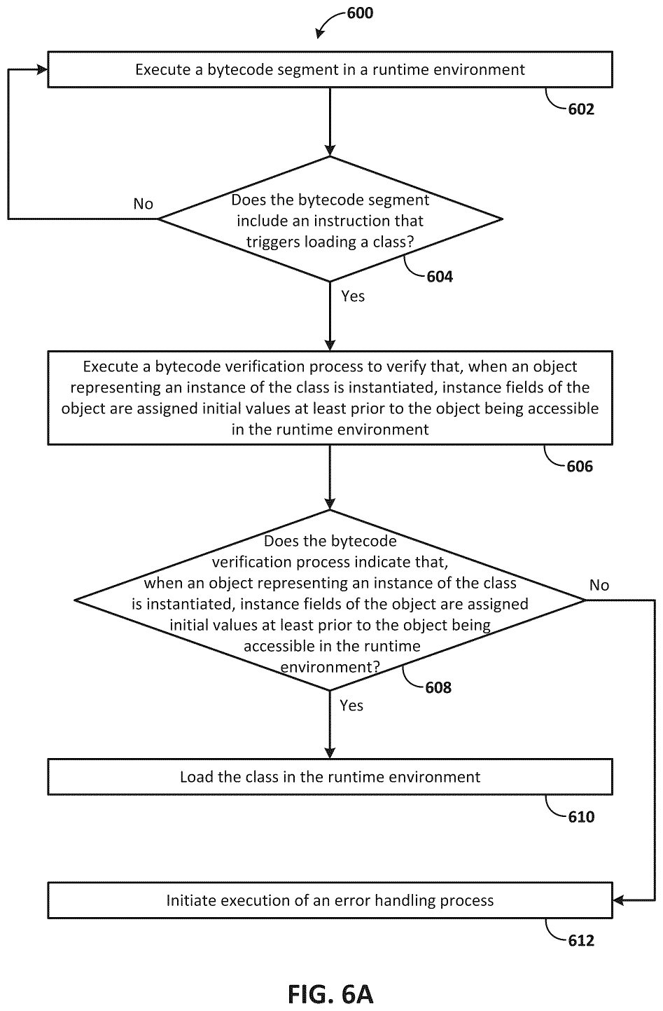

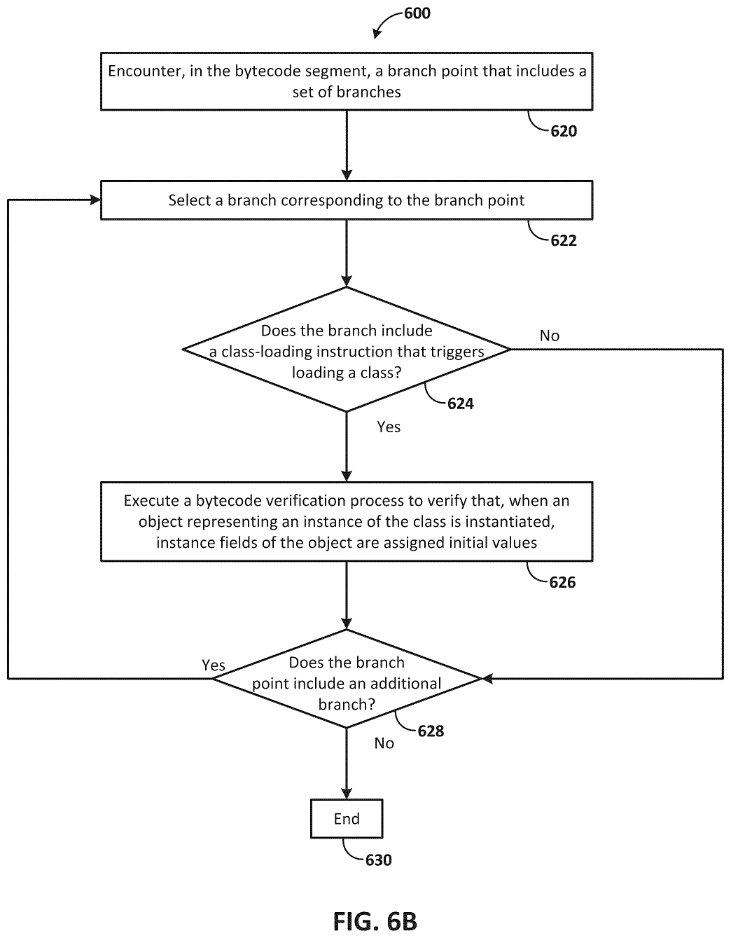

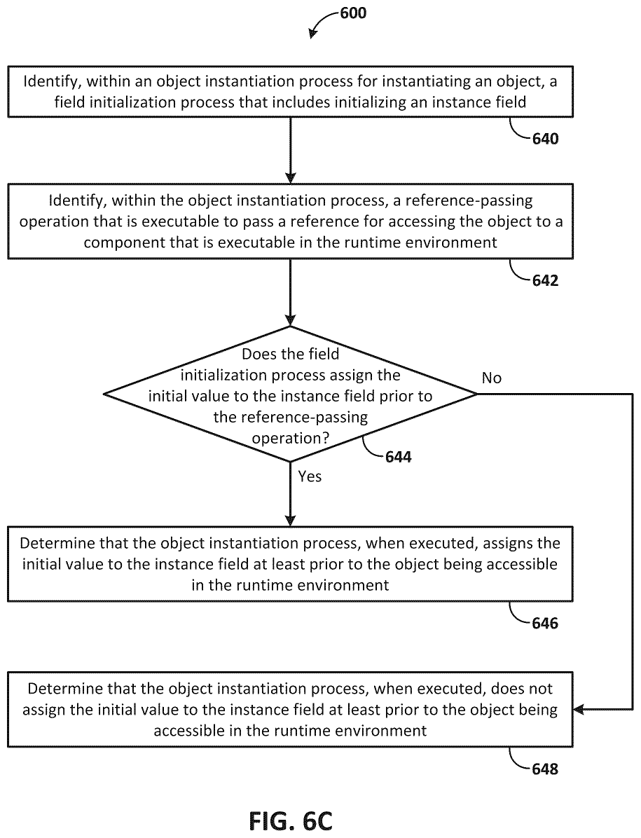

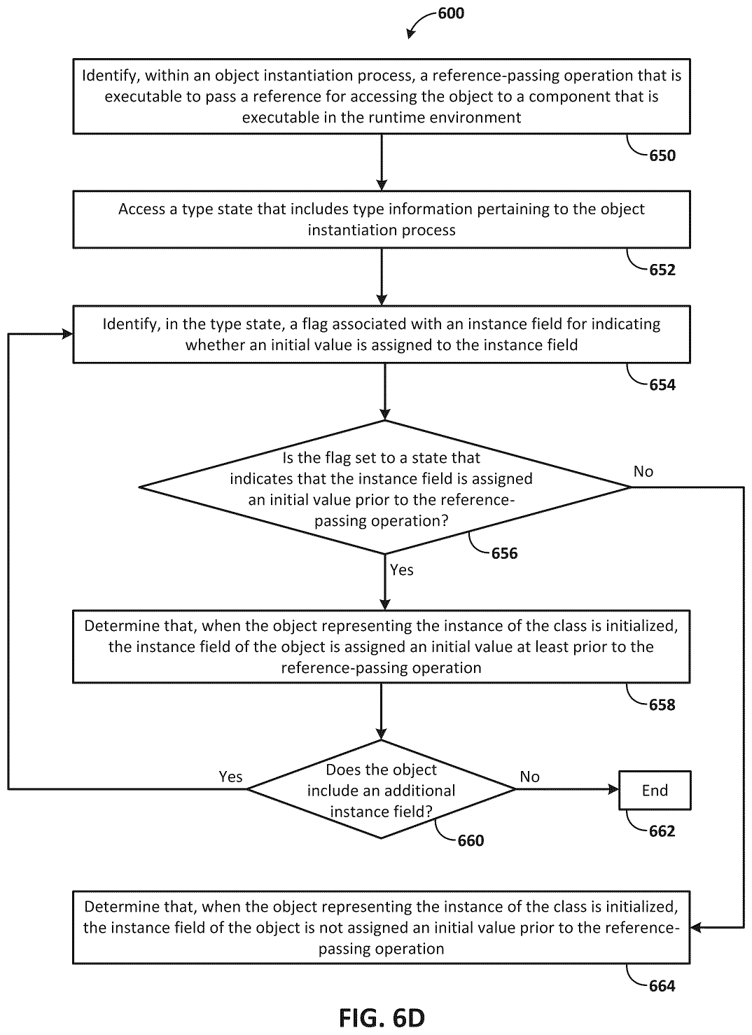

FIG. 5 is a block diagram that illustrates an example of a system according to one or more embodiments. In one or more embodiments, the system 500 refers to hardware and/or software configured to perform operations described herein. Examples of operations are described below with reference to FIGS. 6A-6D, FIGS. 7A-7C, and FIGS. 8A-8D. In one example, the system 500 may include one or more features described above in Section 3, titled “Architectural Overview.”

In one or more embodiments, the system 500 may include more or fewer components than the components described with reference to FIG. 5. The components described with reference to FIG. 5 may be local to or remote from each other. The components described with reference to FIG. 5 may be implemented in software and/or hardware. The components of system 500 may be distributed over multiple applications and/or machines. Multiple components may be combined into one application and/or machine. Operations described with respect to one component may instead be performed by another component.

As described herein, an “engine” or “module” refers to software, hardware, and/or firmware configured to perform the operations described herein with respect to that engine or module. For example, in an object-oriented environment, an engine or module may include one or more compiled class files and/or methods that, when executed, perform the corresponding operations.

As shown in FIG. 5, the system 500 includes one or more of the following: an element configuration engine 502, an initial value verification engine 504, an array generation API 506, or an error handling engine 508. Element configuration engine 502 may include one or more of the following: a class configuration module 510 or an array configuration module 512. Initial value verification engine 504 may include one or more of the following: an instance field verification module 514 or a static field verification module 516. Array generation API 506 may include an array verification module 518.

The element configuration engine 502 executes operations for configuring elements for use in the runtime environment. In one example, the element configuration engine 502 includes a class configuration module 510. The class configuration module 510 executes operations for configuring classes and/or objects that represent instances of a class. The class configuration module 510 may obtain initial values for instance fields of objects that represent instances of a class. Additionally or alternatively, the class configuration module 510 may obtain initial values for static fields of a class.

In one example, the element configuration engine 502 includes an array configuration module 512. The array configuration module 512 executes operations for configuring arrays for use in the runtime environment. The array configuration module 512 may initiate calls to the array generation API 508 to request the array generation API to generate an array for use in the runtime environment. The array configuration module 512 may obtain parameters for generating an array, such as a number of elements of the array and/or initial values for the elements of the array. Additionally or alternatively, the array configuration module 512 may obtain functions for determining parameters for generating an array. The array configuration module may provide the parameters and/or the functions for generating an array to the array generation API.

The initial value verification engine 504 executes operations for verifying that fields are initialized with initial values. The initial value verification engine 504 may condition operations in the runtime environment upon successfully verifying that fields are initialized with initial values. The initial value verification engine 504 may include one or more of the following: an instance field verification module 514, or a static field verification module 516.

The instance field verification module 514 executes operations for verifying that instance fields of an object are populated with initial values prior to the object becoming accessible in the runtime environment. In one example, the instance field verification module 514 is implemented in a virtual machine. The instance field verification module 514 may execute a static analysis to verify that instance fields of an object are populated with initial values prior to the object becoming accessible in the runtime environment. In one example, the instance field verification module 514 executes a bytecode verification process to determine whether instance fields of an object will be populated with initial values prior to the object becoming accessible in the runtime environment. The bytecode verification process is one form of static analysis. The virtual machine executes the bytecode verification process upon bytecode in the runtime environment. The bytecode verification process may be performed upon a bytecode segment prior to executing the bytecode segment. Additionally or alternatively, the instance field verification module 514 may be implemented in an integrated development engine (IDE). The IDE may provide features that support software development such as features for writing, debugging, and testing code. The IDE may execute a static analysis prior to executing code in the runtime environment. The instance field verification module 514 may condition loading of a class on successfully verifying that instance fields of an object that represent an instance of the class are populated with initial values prior to the object becoming accessible in the runtime environment. The instance field verification module 514 may prompt the error handling engine 508 to execute an error handling process when the instance field verification module 514 determines that an instance field of an object will lack an initial value when the object becomes accessible in the runtime environment.

The static field verification module 516 executes operations for verifying that static fields of a class are populated with initial values. The static field verification module 516 is implemented in a virtual machine. The static field verification module 516 may execute a verification process dynamically in the runtime environment to determine whether a static field of a class has been populated with an initial values. The verification process executed by the static field verification module 516 may be performed while executing bytecode in the runtime environment. The static field verification module 516 may perform the verification process upon the first instance when the static field is being accessed in the runtime environment. The static field verification module 516 may condition access to the static field on successfully verifying that the instance field of the static field has been assigned an initial value. The static field verification module 516 may prompt the error handling engine 508 to execute an error handling process when the static field verification module 516 determines that a static field has not been assigned an initial value.

The array generation API 506 generates arrays that are populated with initial values for use in the runtime environment. The array generation API 506 may generate arrays in response to calls from the array configuration module 512. The array generation API 506 may include a constraint that requires that elements of the array are initialized with initial values prior to providing the array for use in the runtime environment. The array generation API 506 may include an array verification module 518. The array verification module 518 may verify that the elements of the array are initialized with initial values prior to providing the array for use in the runtime environment. Additionally or alternatively, the array verification module 518 may represent a portion of the initial value verification engine 504.

The error handling engine 508 may execute one or more error handling processes. The initial value verification engine 504 and/or array generation API 506 may call an error handling process. In one example, the error handling engine 508 executes an error handling process in response to a call initiated from the instance field verification module 514 based on a determination that an instance field of an object that represents an instance of a class will lack an initial value when the object becomes accessible in the runtime environment. The error handling engine 508 may cause the runtime environment to refrain from loading the class. In one example, the error handling engine 508 executes an error handling process in response to a call initiated from the static field verification module 516 based on a determination that a static field has not been assigned an initial value. The error handling engine 508 may cause the runtime environment to refrain from accessing the static field. In one example, the error handling engine 508 may execute operations for obtaining one or more initial values for populating one or more instance fields and/or one or more static fields, for example, from a data repository and/or an input from an input device. Upon obtaining the one or more initial values, the error handling engine 508 may prompt the initial value verification engine 504 to re-execute a verification process.

### 5. Example Operations for Verifying Assignment of Initial Values to Instance Fields of a Class Instance

FIGS. 6A-6D illustrate an example set of operations 600 for verifying assignment of initial values to instance fields of a class instance. One or more operations 600 described with reference to FIGS. 6A-6D may be executed using one or more components of the computing architecture described with reference to FIGS. 1-5. One or more operations 600 described with reference to FIGS. 6A-6D may be modified, combined, rearranged, or omitted. Accordingly, the particular sequence of operations 600 described with reference to FIGS. 6A-6D should not be construed as limiting the scope of one or more embodiments.

Referring to FIG. 6A, a system verifies that initial values are assigned to instance fields of a class instance. As shown in FIG. 6A, the system executes a bytecode segment in a runtime environment (Operation 602). The system loads bytecode into memory. The bytecode includes bytecode instructions. The runtime environment reads and decodes the bytecode instructions. The system translates the bytecode instructions into machine code and/or directly executes the bytecode instructions. While executing a bytecode segment of the bytecode, the system determines whether the bytecode segment includes an instruction that triggers loading a class (Operation 604). When the system determines that the bytecode segment includes an instruction that triggers loading a class, the system executes a bytecode verification process for the class (Operation 606). The system may execute the bytecode verification process upon a bytecode representation of bytecode for loading the class. When the system determines that the bytecode segment does not include an instruction that triggers loading a class, the system continues executing bytecode segments, for example, until the system encounters a bytecode segment that includes an instruction that triggers loading a class.

The bytecode verification process verifies that, when an object representing an instance of the class is instantiated, instance fields of the object are assigned initial values at least prior to the object being accessible in the runtime environment. The object may include one or more instance fields that represent a variable specific to the instance of the class represented by the object. In one example, the bytecode verification process identifies an object instantiation process that is executable to instantiate an object, representing an instance of the class, that includes an instance field representing a variable specific to the instance of the class. Additionally, the bytecode verification process may determine that the object instantiation process, when executed in the runtime environment, assigns an initial value to the instance field at least prior to the object being accessible in the runtime environment. The bytecode verification process may be performed for each instance field of the object. Example operations for the bytecode verification process are further described below with reference to FIGS. 6C and 6D.

The system determines whether the bytecode verification process indicates that when an object representing an instance of the class is instantiated, instance fields of the object are assigned initial values at least prior to the object being accessible in the runtime environment (Operation 608). The bytecode representation of the class passes the bytecode verification process if the system determines that each instance field of the object will be assigned an initial value at least prior to the object being accessible in the runtime environment. The bytecode representation of the class fails the bytecode verification process if the system determines that any one or more instance fields of the object will not be assigned an initial value prior to the object being accessible in the runtime environment.

Loading the class in the runtime environment is contingent upon the system determining that, when an object representing an instance of the class is initialized, instance fields of the object are assigned initial values at least prior to the object being accessible in the runtime environment. When the bytecode verification process indicates that instance fields are assigned initial values at least prior to the object being accessible in the runtime environment, the system loads the class in the runtime environment (Operation 610). In one example, the system loads a bytecode representation of the class in the runtime environment. The system may utilize a class loader to load the class in the runtime environment. The class loader locates a class file for the class in a class directory or archive. Upon locating the class file for the class, the system executes bytecode of the class file to load the class in the runtime environment.

When the bytecode verification process indicates that one or more instance fields of an object are not assigned initial values prior to the object being accessible in the runtime environment, the system initiates execution of an error handling process (Operation 612). The error handling process may refrain from loading the class in the runtime environment. Additionally or alternatively, the error handling process may generate an exception and directing the exception to an exception handler for processing. Additionally or alternatively, the error handling process may obtain one or more initial values for populating one or more instance fields of the object, for example, from a data repository and/or an input from an input device. Upon obtaining the one or more initial values, the system may re-execute the bytecode verification process for the object at Operation 606.

The system may encounter instructions that trigger loading a class in multiple branches of bytecode. In one example, the system encounters a branch point in a bytecode segment that includes multiple branches such as a first branch and a second branch. One or more of the branches may include an instruction that triggers loading a class. The system may evaluate each branch of a branch point to determine whether a particular branch includes instructions that triggers loading a class at operation 604. Additionally or alternatively, the system may execute a particular branch in the runtime environment at operation 602 and, when executing the particular branch, the system may encounter an instruction that triggers loading a class at operation 604 6A.

As shown in FIG. 6B, the system encounters a branch point in the bytecode segment that includes a set of branches (Operation 620). The system selects a branch corresponding to the branch point (Operation 622). The system determines whether the branch includes a class-loading instruction that triggers loading a class (Operation 624). When the system determines that the branch includes a class-loading instruction that triggers loading a class, the system executes a bytecode verification process to verify that when an object representing an instance of the class is instantiated, instance fields of the object are assigned initial values at least prior to the object being accessible in the runtime environment (Operation 626). Upon having executed the bytecode verification process for a branch at operation 626 and/or upon having determined that a branch does not include a class-loading instruction at operation 624, the system determines whether the branch point includes an additional branch (Operation 628). When the system determines that the branch point includes an additional branch, the system selects the additional branch at operation 622 and determines whether the additional branch includes a class-loading instruction that triggers loading a class at operation 624. The operations 600 for the branch point may end when the system determines that the branch point does not include an additional branch (Operation 630).

In addition to encountering a branch point in a bytecode segment, the system may encounter a branch point within a class-loading instruction. Additionally or alternatively, the system encounters a branch within a constructor that is executed in response to a class-loading instruction. In one example, the system encounters a branch point that includes multiple branches when executing a bytecode verification. One or more branches of the branch point within the class-loading instruction and/or the constructor may trigger loading a class. Additionally or alternatively, the particular class that is loaded may differ as between the multiple branches of the class-loading instruction and/or as between the multiple branches of the constructor. Additionally or alternatively, the particular instance fields of an object representing an instance of the class may differ as between the multiple branches of the class-loading instruction and/or as between the multiple branches of the constructor. The system may execute a bytecode verification process for each branch of the branch point within the class-loading instruction and/or for each branch of the branch point within the constructor. The bytecode verification process verifies that, for each branch of the branch point, any instance fields are assigned initial values.

In one example, the constructor for “class D” may include code include a branch point in the form of an if-statement, for example, as follows:

```
class D {
  String s;
D(boolean cond) {
    if (cond) { s = “x”; }
  else { }
  super( );
  }
}
```

In the foregoing example, the system verifies whether, for an execution path of the constructor that reaches “super( )”, any instance fields are assigned an initial value. In the foregoing example, a first branch represents a state when “(cond)” is true and a second branch represents a state when “(cond)” is false. For the first branch, instance field “s” is assigned an initial value “x”. For the second branch, an initial value is not assigned to instance field “s”. Thus, the system determines that the constructor fails the verification based on the second branch path. The class-loading instruction and/or the constructor passes the bytecode verification process when the system determines that each branch passes the bytecode verification process.

FIGS. 6C and 6D illustrate an example set of operations 600 for bytecode verification. One or more operations 600 described with reference to FIG. 6C and/or FIG. 6D may be included in operation 606 of FIG. 6A. As described with reference to FIG. 6C, in one example, the bytecode verification process may verify that, when an object representing an instance of a class is instantiated, instance fields of the object are assigned initial values at least prior to a reference-passing operation that is executable to pass a reference for accessing the object to a component that is executable in the runtime environment. Additionally or alternatively, as described with reference to FIG. 6D, the bytecode verification process may verify that, when an object representing an instance of a class is instantiated, a flag associated with an instance field, for indicating whether an initial value is assigned to the instance field, is set to a state that indicates that an initial value is assigned to the instance field prior to the reference-passing operation.

The reference-passing operation may include a call to a component that is executable in the runtime environment. The call to the component may include a reference for accessing the object. The component may utilize the reference to access the object, or the component may be capable of utilizing the reference to access the object. In one example, the object instantiation process includes a constructor that, when executed, initiates the call to the component.

In one example, the component is a superclass constructor of a superclass associated with the object and the reference-passing operation is a call from a constructor to the superclass constructor. The class of the object may be a subclass of the superclass. In one example, the call to the superclass constructor represents a point in the object instantiation process where the constructor passes control of the object instantiation process to the superclass constructor. The superclass constructor may be executable, in response to the call from the constructor, to initialize one or more inherited fields that the object from the superclass. In one example, the call to the superclass constructor is the first statement in the constructor. The call to the superclass constructor may be an explicit call statement in the constructor for the constructor to call a particular superclass constructor. Alternatively, the call to the superclass constructor may be a call to a no-argument constructor of a superclass. The system may insert the call to a no-argument constructor when the constructor does not include an explicit call to a particular superclass constructor.

In one example, the component includes an initialization method, and the reference-passing operation includes a call to the initialization method. The initialization method may perform one or more initialization operations associated with the object.

In one example, the component includes an event listener, and the reference-passing operation includes a call to the event listener. The event listener may perform one or more event-listening operations associated with the object. For example, the event listener may monitor the object for one or more specified events and respond when a specified event occurs. In one example, the event listener prompts the object to handle specified events by prompting the object to perform operations when specified events occur.

In one example, the component includes a callback, and the reference-passing operation includes the object or a reference to the object being passed as a callback, for example, to one or more additional components. The callback may allow the one or more additional components to notify the object when certain conditions are met.

In one example, the component includes a thread, and the reference-passing operation includes initiating the thread. The thread may be initiated to allow for performance of asynchronous operations. In one example, the thread is initialized to allow the object to be instantiated asynchronously, such as in a set of background operations and/or concurrently with an additional set of concurrent operations.

In one example, the reference-passing operation represents an initial instance of the object being accessible in the runtime environment. Additionally or alternatively, the reference-passing operation represents a subsequent instance of the object being accessible in the runtime environment. Additionally or alternatively, the reference-passing operation may represent an instance when a component that is executable in the runtime environment is capable of accessing the object.

As shown in FIG. 6C, the system identifies a field initialization process within an object instantiation process for instantiating an object (Operation 640). The field initialization process includes one or more operations for initializing an instance field. In one example, the one or more operations for initializing the instance field include assigning an initial value to the instance field. In one example, the operations 600 include determining whether the one or more operations for initializing the instance field include assigning an initial value to the instance field. In addition to identifying the field initialization process, the system identifies a reference-passing operation within the object instantiation process (Operation 642). The reference-passing operation is executable to pass a reference for accessing the object to a component that is executable in the runtime environment. In one example, the system may identify the reference-passing operation at least by identifying a segment of the object instantiation process that includes the reference-passing operation. The system may identify a segment of the object instantiation process that includes the reference-passing operation, and then upon identifying the segment of the object instantiation process that includes the reference-passing operation, the system may identify the reference-passing operation in the segment of the object instantiation process. Additionally or alternatively, the system may identify the reference-passing operation by identifying a segment of the object instantiation process that is known to include the reference-passing operation, for example, without explicitly identifying the reference-passing operation within the segment.

Upon having identified the field initialization process and the reference-passing operation, the system determines whether the field initialization process assigns the initial value to the instance field prior to the reference-passing operation (Operation 644). Additionally or alternatively, the system determines whether the field initialization process occurs at least prior to the reference-passing operation. In one example, the field initialization process includes updating type information in a type state associated with the object instantiation process. The type information may indicate whether the field initialization process assigns the initial value to the instance field. Additionally or alternatively, the type information may indicate a point in the object instantiation process when the field initialization process assigns the initial value to the instance field. Based on the type information, the system determines whether the field initialization process assigns the initial value to the instance field prior to the reference-passing operation. In one example, the system identifies a segment of the object instantiation process that includes the reference-passing operation at operation 642, and then at operation 644, the system determines whether the instance field is assigned the initial value prior to the segment that includes the reference-passing operation.

In one example, the system identifies a constructor invocation point in the object instantiation process. The constructor invocation point represents a point in the object instantiation process where a constructor commences executing operations of an object initialization process for initializing the object. The object becomes accessible in the runtime environment as a result of the object initialization process. For example, the object initialization process for initializing the object includes a reference-passing operation, such as a call to a superclass constructor. The system determines whether the object instantiation process assigns the initial value to the instance field at least prior to the constructor invocation point. In one example, the system determines whether the object instantiation process assigns the initial value to the instance field at least prior to the constructor invocation point based on a field initialization process that includes initializing an instance field of the object and/or assigning an initial value to the instance field. The system may identify a point in the field initialization process where the instance field is initialized. Additionally, the system may determine whether the field initialization process includes assigning an initial value to the instance field. Additionally or alternatively, the system may determine whether the initial value is assigned to the instance field by the field initialization process prior to the constructor invocation point.

In one example, the system identifies a superclass invocation point in the object instantiation process. The superclass invocation point represents a point in the object instantiation process where a constructor passes control of the object instantiation process to a superclass constructor. The object becomes accessible in the runtime environment, for example, at least by the superclass constructor, as a result of the constructor passing control of the object instantiation process to the superclass constructor. For example, the superclass invocation point includes a reference-passing operation, such as a call to the superclass constructor. The system determines whether the object instantiation process assigns the initial value to the instance field at least prior to the superclass invocation point. In one example, the system determines whether the object instantiation process assigns the initial value to the instance field at least prior to the superclass invocation point based on a field initialization process that includes initializing an instance field of the object and/or assigning an initial value to the instance field. The system may identify a point in the field initialization process where the instance field is initialized. Additionally, the system may determine whether the field initialization process includes assigning an initial value to the instance field. Additionally or alternatively, the system may determine whether the initial value is assigned to the instance field by the field initialization process prior to the superclass invocation point.

When the system determines that the field initialization process assigns the initial value to the instance field prior to the reference-passing operation, the system determines that the object instantiation process, when executed, assigns the initial value to the instance field at least prior to the object being accessible in the runtime environment (Operation 646). Additionally or alternatively, when system determines that the field initialization process does not assign the initial value to the instance field prior to the reference-passing operation, the system determines that the object instantiation process, when executed, does not assign the initial value to the instance field at least prior to the object being accessible in the runtime environment (Operation 648). For example, the system may determine that the field initialization process assigns the initial value to the instance field subsequent to the reference-passing operation. When the system determines that the field initialization process assigns the initial value to the instance field subsequent to the reference-passing operation, the system determines that the object instantiation process does not assign the initial value to the instance field at least prior to the object being accessible in the runtime environment. Additionally or alternatively the system may determine that the field initialization process does not assign the initial value to the instance field. When the system determines that the field initialization process does not assign the initial value to the instance field, the system determines that the object instantiation process does not assign the initial value to the instance field at least prior to the object being accessible in the runtime environment.

As shown in FIG. 6D, the system may identify a reference-passing operation within an object instantiation process. The reference-passing operation represents a point when the object becomes accessible in the runtime environment. The reference-passing operation is executable to pass a reference for accessing the object to a component that is executable in the runtime environment (Operation 650). Additionally, the system may access a type state that includes type information for the object instantiation process (Operation 652). The system may access the type state in metadata associated with the class, for example, using a reflection API. The reflection API may allow the system to examine the type state at different stages of the object instantiation process.

Upon having accessed the type state, the system identifies a flag in the type state that is associated with an instance field (Operation 654). The flag is configured to indicated whether an initial value is assigned to the instance field. The flag is set to a first state prior to the instance field being assigned an initial value. In one example, the first state may indicate that a default value is assigned to the instance field, such as a value of “0” (zero), “false,” or “null.” Additionally or alternatively, the first state may indicate that the instance field has not been assigned any value. The flag is set to a second state prior when the initial value is assigned to the instance field. The initial value may include one or more of the following: a literal value, a constant value, a string, an expression, a method call, or an object. In one example, the initial value is a default value that is explicitly assigned to the instance field. In one example, the initial value of the instance field is an array.

The system determines whether the flag is set to a state that indicates that the instance field is assigned an initial value prior to the reference-passing operation (Operation 656). The system may identify the state of the flag at a point in the object instantiation process that is prior to the reference-passing operation. Additionally or alternatively, the system may identify the state of the flag at an invocation point for the reference-passing operation. Prior to the reference-passing operation, if the flag is set to the state that indicates that the instance field is assigned an initial value, the system determines that when the object representing the instance of the class is initialized, the instance field of the object is assigned an initial value at least prior to the reference-passing operation (Operation 658).

In one example, the system determines that the object instantiation process assigns the initial value to the instance field at least prior to a constructor invocation point where a constructor commences executing operations of an object initialization process for initializing the object. The system may identify the constructor invocation point. Additionally, the system may determine that, at least prior to the constructor invocation point, the flag is set to the state that indicates that the instance field is assigned an initial value. Based at least in part on determining that the flag is set to the state that indicates that the instance field is assigned an initial value at least prior to the constructor invocation point, the system may determine that the object instantiation process assigns the initial value to the instance field at least prior to the constructor invocation point.

In one example, the system determines that the object instantiation process assigns the initial value to the instance field at least prior to a superclass invocation point for a constructor to pass control of the object instantiation process to a superclass constructor. The system may identify the superclass invocation point for the constructor to pass control of the object instantiation process to the superclass constructor. Additionally, the system may determine that, at least prior to the superclass invocation point, the flag is set to the state that indicates that the instance field is assigned an initial value. Based at least in part on determining that the flag is set to the state that indicates that the instance field is assigned an initial value at least prior to the superclass invocation point, the system may determine that the object instantiation process assigns the initial value to the instance field at least prior to the superclass invocation point.

Upon determining that the instance field of the object is assigned an initial value at least prior to the reference-passing operation when the object representing the instance of the class is initialized, the system determines whether the object includes an additional instance field (Operation 660). The operations 600 may end when the system determines that the object does not include an additional instance field (Operation 662). Alternatively, when the system determines that the object includes an additional instance field, the system identifies an additional flag in the type state that is associated with the additional instance field (Operation 654). If the system determines that a flag in the type state associated with an instance field is set to a state that indicates that the instance field is not assigned an initial value prior to the reference-passing operation, the system determines that, when the object representing the instance of the class is initialized, the instance field is not assigned an initial value prior to the reference-passing operation (Operation 664).

When the system determines that an instance field of an object is not assigned an initial value prior to the object becoming accessible on the runtime environment, such as prior to the reference-passing operation (e.g., at operation 648 of FIG. 6C and/or at operation 664 of FIG. 6D), the system initiates an error handling process at operation 612 of FIG. 6A. The error handling process may prevent the class from being loaded, for example, by throwing an exception or error.

In one example, if the system encounters a branch point within a class-loading instruction and/or within a constructor, the system evaluates the type state for each branch of the branch point. The different branches of may produce different type states, for example, because the different branches included different instructions. For each branch, the system identifies, in the type state for each branch, any flag associated with an instance field for indicating whether an initial value is assigned to the instance field. Additionally, for each branch, the system determines whether any flags that are identified are set to a state that indicates that the instance field is assigned an initial value prior to the reference-passing operation.

### 6. Example Operations for Verifying Assignment of Initial Values to Static Fields of a Class

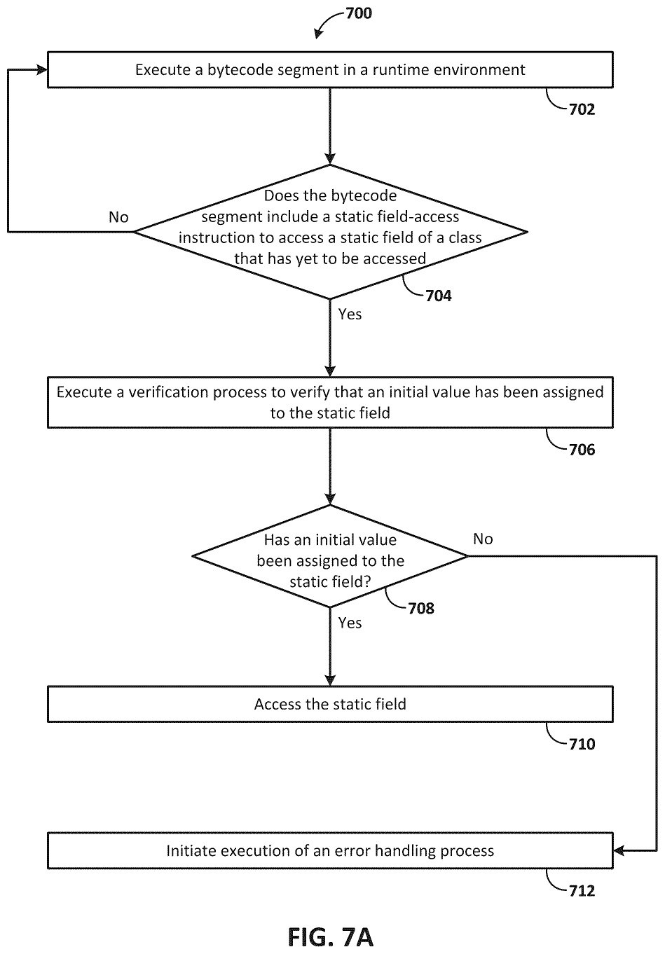

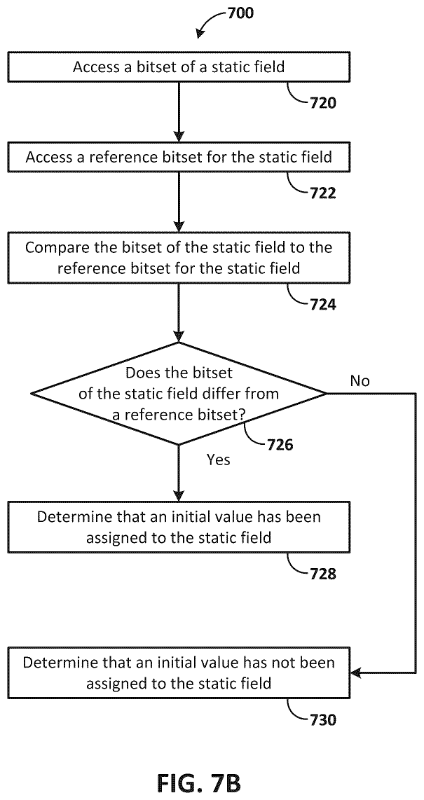

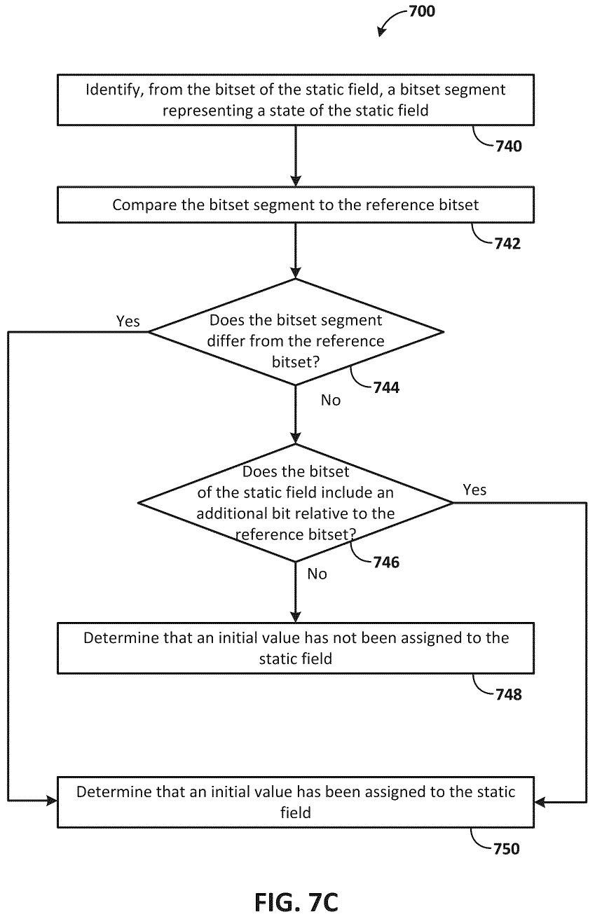

FIGS. 7A-7C illustrate an example set of operations 700 for verifying assignment of initial values to static fields of a class according to one or more embodiments. One or more operations 700 described with reference to FIGS. 7A-7C may be executed using one or more components of the computing architecture described with reference to FIGS. 1-5. One or more operations 700 described with reference to FIGS. 7A-7C may be included in and/or combined with one or more operations 600 described with reference to FIGS. 6A-6D. Additionally or alternatively, one or more operations 700 described with reference to FIGS. 7A-7C may be modified, combined, rearranged, or omitted. Accordingly, the particular sequence of operations 700 described with reference to FIGS. 7A-7C should not be construed as limiting the scope of one or more embodiments.

Referring to FIG. 7A, the system performs a dynamic analysis to verify that a static field has been assigned an initial value in response to encountering a static field-access instruction for accessing the static field. As shown in FIG. 7A, the system executes a bytecode segment in a runtime environment (Operation 702). The system loads bytecode into memory. The bytecode includes bytecode instructions. The runtime environment reads and decodes the bytecode instructions. The system translates the bytecode instructions into machine code and/or directly executes the bytecode instructions. While executing a bytecode segment of the bytecode, the system determines whether the bytecode segment includes a static field-access instruction to access a static field of a class that has yet to be accessed (Operation 704).

In one example, the static field-access instruction triggers the verification process when the static field has yet to be accessed. Additionally or alternatively, the static field-access instruction may trigger the verification process only when the static field has yet to be accessed. Alternatively, the system may determine whether the static field has been previously accessed prior to executing the verification process or as part of the verification process. In one example, the system may determine whether the static field has been accessed based on a flag associated with the static field. The system may identify a flag associated with the static field for indicating whether the static field has been accessed. The system may determine that the flag is set to a first state that indicates that the static field has yet to be accessed. Based on determining that the flag is set to the first state, the system may determine that the static field has yet to be accessed. Additionally or alternatively, the system may determine that the flag is set to a second state that indicates that the static field has previously been accessed. Based on determining that the flag is set to the second state, the system may determine that the static field has previously been accessed.

When the system determines that the bytecode segment includes a static field-access instruction to access a static field of a class that has yet to be accessed, the system executes a verification process to verify that an initial value has been assigned to the static field (Operation 706). Example operations 700 for the verification process are further described below with reference to FIGS. 7B and 7C.

In one example, a default value is assigned to the static field, such as a value of “0” (zero), “false,” or “null.” Additionally or alternatively, the static field may not be assigned any value. Additionally or alternatively, an initial value may be assigned to the static field. The initial value may include one or more of the following: a literal value, a constant value, a string, an expression, a method call, or an object. In one example, the initial value is a default value that is explicitly assigned to the static field. In one example, the initial value of the static field is an array. The initial value of the static field may be applicable to multiple class instances of a class.

The system determines whether an initial value has been assigned to the static field (Operation 708). The static field passes the verification process when the system determines that the static field has been assigned an initial value. The static field fails the verification process when the system determines that the static field has not been assigned an initial. When the system determines that the static field has been assigned an initial value, the system accesses the static field (Operation 710). The system may access the static field to perform an initialization process for initializing the class corresponding to the static field in a runtime environment. In one example, the system encounters an instruction that triggers initializing the class in the runtime environment. The system may commence an initialization process for initializing the class, and during the initialization process, the system may encounter the static field-access instruction to access the static field. Additionally or alternatively, the initialization process for initializing the class may initialize one or more static fields of the class. In one example, the system may determine that a static field has yet to be initialized. The system may initialize the static field in response to determining that the static field has yet to be initialized. In one example, the system may assign an initial value to the static field when initializing the static field. Alternatively, upon initializing the static field, the static field may not yet have an initial value. In one example, the system may assign a default value to the static field when initializing the static field. The default value may be overwritten with the initial value. Additionally or alternatively, the system may expressly assign the default value as the initial value. Additionally or alternatively, the static field may have a default value when the system has not assigned an initial value to the static field. The system may encounter the static field-access instruction subsequent to initializing the class and/or subsequent to initializing the static field.

When the system determines that the static field has not been assigned an initial value, the system initiates execution of an error handling process (Operation 712). The error handling process may refrain from initializing the class. Additionally or alternatively, the error handling process may generate an exception and directing the exception to an exception handler for processing. Additionally or alternatively, the error handling process may obtain an initial value for populating the static field, for example, from a data repository and/or an input from an input device. Upon populating the static field with the initial value, the system may re-execute the verification process at Operation 706.

FIGS. 7B and 7C illustrate an example set of operations 700 for verifying that a static field has been assigned an initial value. One or more operations 700 described with reference to FIG. 7B and/or FIG. 7C may be included in operation 706 of FIG. 7A. As described with reference to FIG. 7B, the system determines whether the static field has been assigned an initial value based on a bitset of the static field. As shown in FIG. 7B, the system accesses a bitset of the static field (Operation 720). The bitset of the static field represents a state of the static field. Additionally, the system accesses a reference bitset for the static field (Operation 722). The reference bitset represents the bitset of the static field when the bitset has not yet been assigned an initial value. The system may utilize a class loader to access the bitset of the static field and/or the reference bitset for the static field. The class loader may access the bitset of the static field by referencing a memory address of the bitset. Additionally or alternatively, the class loader may access the reference bitset for the static field by referencing a memory address of the reference bitset.

The system compares the bitset of the static field to the reference bitset for the static field (Operation 724). Based on the comparison of the bitset to the reference bitset, the system determines whether the bitset of the static field differs from the reference bitset (Operation 726). When the bitset of the static field differs from the reference bitset, the system determines that an initial value has been assigned to the static field (Operation 724). When the bitset of the static field does not differ from the reference bitset, the system determines that an initial value has not been assigned to the static field (Operation 726).

FIG. 7C illustrates an example set of operations 700 for comparing the bitset of the static field to the reference bitset of the static field. One or more operations 700 described with reference to FIG. 7C may be included in operation 724 of FIG. 7B. As described with reference to FIG. 7C, the system may utilize a bitset segment of the bitset for the static field to indicate whether an initial value has been assigned to the static field. Additionally or alternatively, the system may utilize an additional bit of the bitset for the static field to indicate that a default value has been expressly assigned to the static field. The additional bit is utilized to distinguish between a scenario where the static field has a default value because an initial value has not been assigned to the static field and a scenario where the default value has been expressly assigned to the static field as the initial value.

As shown in FIG. 7C, the system identifies a bitset segment from the bitset of the static field (Operation 740). The bitset segment represents a value of the static field. The bitset segment may represent all or a portion of the bitset for the static field. For example, the bitset segment may include bits 1-n of the bitset. The system compares the bitset segment to the reference bitset (Operation 742). The comparison of the bitset segment to the reference bitset indicates whether the value of the static field is the default value.

The system determines whether the bitset segment differs from the reference bitset (Operation 744). When the bitset segment differs from the reference bitset, the value of the static field is not the default value. When the bitset segment differs from the reference bitset, the system determines that an initial value has been assigned to the static field. When the bitset segment matches the reference bitset, the value of the static field matches the default value. The system determines whether the default value has been expressly assigned to the static field by determining whether the bitset of the static field includes an additional bit relative to the reference bitset (Operation 746). In one example, the additional bit is added to the bitset for the static field when the default value has been expressly assigned to the static field. In one example, the additional bit is utilized only when the default value has been expressly assigned to the static field. Alternatively, the bitset for the static field may include a bit that is set when the default value has been expressly assigned to the static field.

When the bitset of the static field does not include the additional bit relative to the reference bitset, the system determines that an initial value has not been assigned to the static field (Operation 748). When the bitset of the static field does not include the additional bit, the static field may have a default value as a result of the initial value having yet to be assigned to the static field. When the bitset of the static field includes the additional bit relative to the reference bitset, the system determines that the initial value has been assigned to the static field (Operation 750). The additional bit indicates that the default value has been expressly assigned to the static field as the initial value.

In one example, the system may determine whether an initial value has been assigned to the static field based on a flag associated with the static field. The system may identify a flag associated with the static field for indicating whether the static field has been assigned an initial value. The system may determine that the flag is set to a first state that indicates that the static field has not been assigned an initial value. Based on determining that the flag is set to the first state, the system may determine that the static field has yet to be assigned an initial value. Additionally or alternatively, the system may determine that the flag is set to a second state that indicates that the static field has been assigned an initial value. Based on determining that the flag is set to the second state, the system may determine that the static field has been assigned an initial value.

7. Example Operations for Generating Arrays that are Initialized with Initial Values

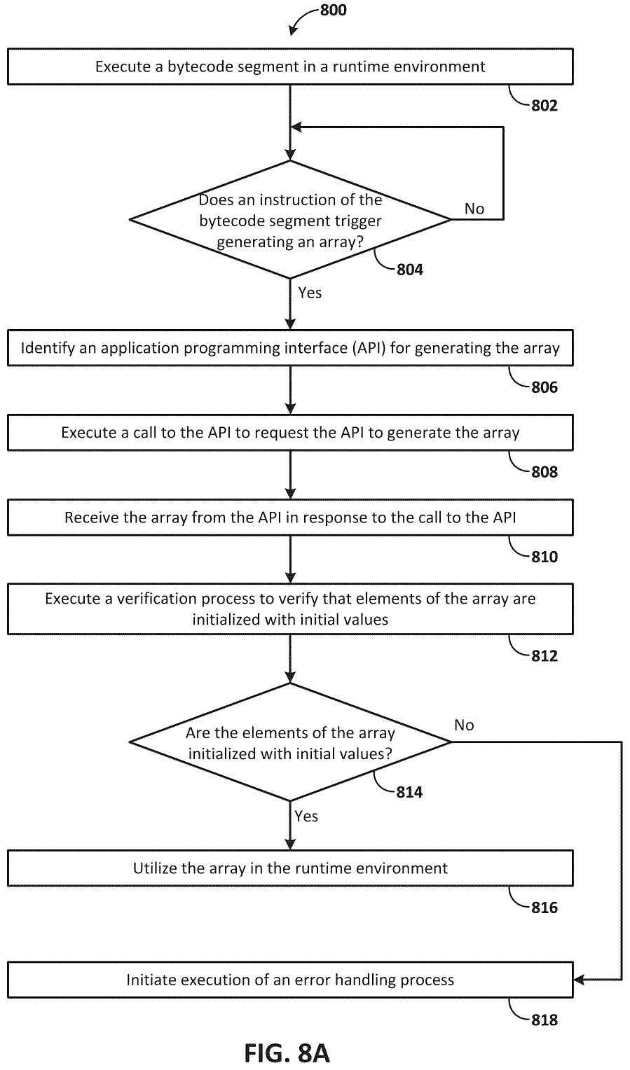

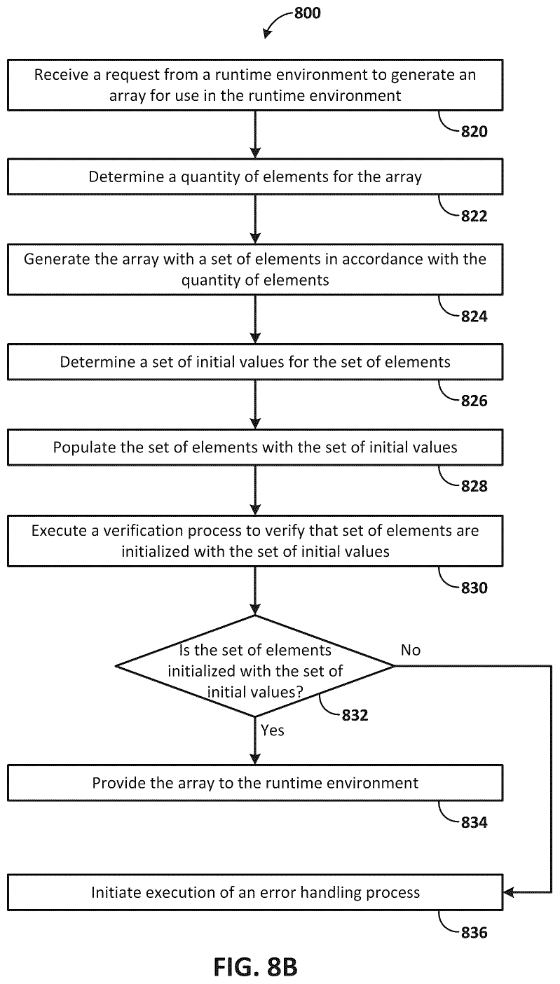

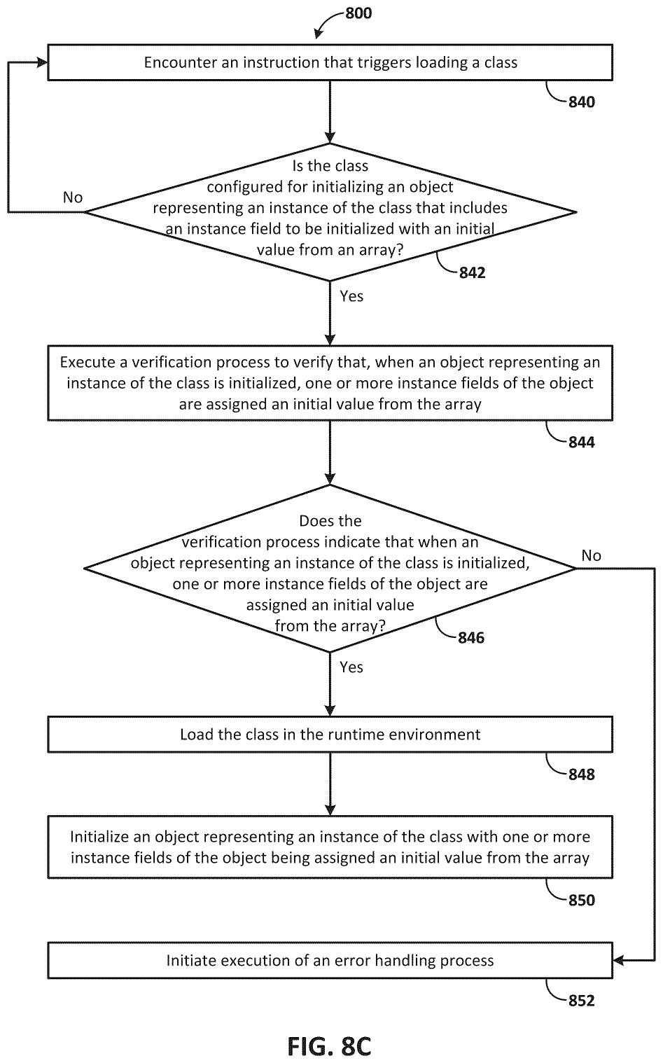

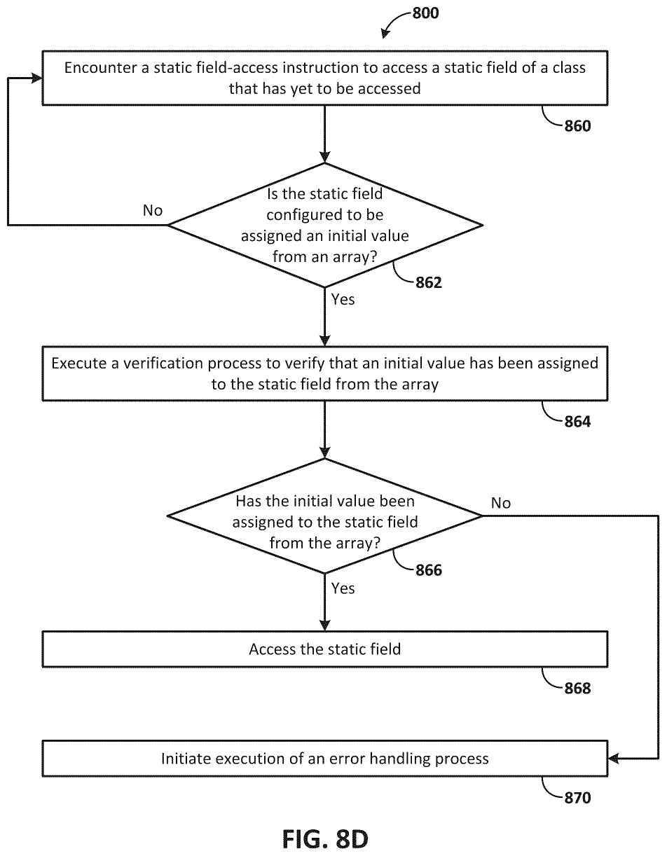

FIGS. 8A-8D illustrate an example set of operations 800 for generating arrays that are initialized with initial values in accordance with one or more embodiments. One or more operations 800 described with reference to FIGS. 8A-8D may be executed using one or more components of the computing architecture described with reference to FIGS. 1-5. One or more operations 800 described with reference to FIGS. 8A-8D may be included in and/or combined with one or more operations 600 described with reference to FIGS. 6A-6D and/or with one or more operations 700 described with reference to FIGS. 7A-7C. Additionally or alternatively, one or more operations 700 described with reference to FIGS. 8A-8D may be modified, combined, rearranged, or omitted. Accordingly, the particular sequence of operations 800 described with reference to FIGS. 8A-8D should not be construed as limiting the scope of one or more embodiments.

Referring to FIG. 8A, a system obtains an array for use in a runtime environment by calling an API that generates the array in accordance with a constraint requiring that elements of the array are initialized with initial values. As shown in FIG. 8A, the system executes a bytecode segment in a runtime environment (Operation 802). The system loads bytecode into memory. The bytecode includes bytecode instructions. The runtime environment reads and decodes the bytecode instructions. The system translates the bytecode instructions into machine code and/or directly executes the bytecode instructions. While executing a bytecode segment of the bytecode, the system determines whether the bytecode segment includes an instruction that triggers generating an array (Operation 804). When the system determines that the bytecode segment includes an instruction that triggers generating an array, the system identifies an API for generating the array (Operation 806). The system may identify the API in a registry of available APIs. Additionally or alternatively, the system may identify the API based on a configuration file, reflection, annotations, or metadata.

Upon identifying the API, the system executes a call to the API to request the API to generate the array (Operation 808). Upon the API having generated the array, then system receives the array from the API in response to the call to the API (Operation 810). In one example, the system executes a verification process to verify that elements of the array are initialized with initial values (Operation 812). Additionally or alternatively, the API may execute a verification process to verify that elements of the array are initialized with initial values prior to providing the API for use in the runtime environment. Based on the verification process, the system determines whether the elements of the array are initialized with initial values (Operation 814). When the system determines that the elements of the array are initialized with initial values, the system utilizes the array in the runtime environment (Operation 816). When the system determines that one or more elements of the array are not initialized with initial values, the system initiates execution of an error handling process (Operation 818). The error handling process may refrain from utilizing the array in the runtime environment for example, at least until the system determines in a subsequent verification process that the elements of the array are initialized with initial values. In one example, the error handling process executes a call to the API to request the API to add initial values to the array.

Referring to FIG. 8B, in response to a request from the runtime environment, the API generates an array for use in a runtime environment. As shown in FIG. 8B, the system receives a request from the runtime environment to generate the array (Operation 820). In response to the request to generate the array, the API determines a quantity of elements for the array (Operation 822). In one example, the request to generate the array includes an indication of the quantity of elements for the array. Additionally or alternatively, the request may include an element quantity package for the API to determine the quantity of elements for the array. The element quantity package may identify the quantity of elements. Additionally or alternatively, the element quantity package may include a function for determining the quantity of elements. In one example, the API determines the quantity of elements for the array based on a data repository that indicates the quantity of elements for the array. The API may access the data repository and determine the quantity of elements based on a quantity of elements indicated in the data repository. In one example, the API determines the quantity of elements based on a function. The API may execute the function to determine the quantity of elements. Upon having determined the quantity of elements, the API generates the array with a set of elements in accordance with the quantity of elements (Operation 824).

Further in response to the request to generate the array, the API determines a set of initial values for the set of elements (Operation 826). The set of initial values may include at least one of: a set of classes, a set of methods, as set of references to classes or methods, a set of static fields, a set of instance fields, a set of calls, a set of expressions, a set of results of expressions, a set of literals, a set of constants, or a set of default values. In one example, the request to generate the array includes an indication of the initial values for the elements of the array. Additionally or alternatively, the request may include an initial value package for the API to determine the initial values for the elements of the array. The initial values package may identify the initial values. Additionally or alternatively, the initial values package may include a function for determining the initial values. In one example, the API determines the set of initial values for the array based on a data repository that includes the set of initial values. The API may access the data repository and determine the initial values based from the data repository. In one example, the API determines the initial values based on a function. The API may execute the function to determine the initial values. Upon having determined the initial values for the set of elements of the array, the API populates the set of elements with the set of initial values (Operation 828). In one example, the API populates the set of elements with the initial values from the data repository.

In one example, the API executes a verification process to verify that the set of elements are initialized with the set of initial values (Operation 830). Based on the verification process, the API determines whether the set of elements are initialized with the set of initial values (Operation 832). The verification process performed by the API includes one or more operations to verify that the set of elements actually include initial values. In one example, the API verifies that the number of initial values for populating the elements of the array match the number of elements of the array. Additionally or alternatively, the API may identify any elements that are populated with a default value and verify that the default value is intended as an initial value. Additionally or alternatively, the API may verify that the initial values in the array match a source set of initial values provided to the API or obtained by the API when generating the array. When the API determines that the elements of the array are initialized with initial values, the API provides the array to the runtime environment (Operation 834). In one example, the API includes a constraint that requires the elements of the array to be initialized with initial values prior to providing the array to the runtime environment. When the API determines that one or more elements of the array are not initialized with initial values, the API initiates execution of an error handling process (Operation 836). The error handling process may refrain from providing the array to the runtime environment for example, at least until the API determines in a subsequent verification process that the elements of the array are initialized with initial values. In one example, the error handling process causes the API to obtain initial values for the array.

Referring to FIG. 8C, in one example, the system loads a class that is configured for initializing an object representing an instance of the class that includes an instance field that is initialized with an initial value from an array. As shown in FIG. 8C, the system encounters an instruction that triggers loading a class (Operation 840). In response to the instruction, the system determines whether the class is configured for initializing an object representing an instance of the class that includes an instance field to be initialized with an initial value from an array (Operation 842). The system may determine whether an instance field is to be initialized with an initial value from an array based on a declaration for the instance field. The system may analyze the instance field through code inspection, reflection, or by reading configuration files or annotations.

When the system determines that the class is configured for initializing an object that includes an instance field to be initialized with an initial value from an array, the system executes a verification process to verify that, when an object representing an instance of the class is initialized, one or more instance fields of the object are assigned an initial value from the array (Operation 844). The verification process may include verifying that elements of the array are initialized with initial values, for example, as described with reference to FIG. 8A and/or FIG. 8B. Additionally or alternatively, the verification process may include a bytecode verification process as described with reference to FIGS. 6A-6D.

The system determines whether the verification process indicates that, when an object representing an instance of the class is initialized, one or more instance fields of the object are assigned an initial value from the array (Operation 846). In one example, the system determines that the one or more instance fields of the object are assigned an initial value from the array based on having determined that elements of the array are initialized with initial values. Additionally or alternatively, the system may determine, based on a bytecode verification, that the one or more instance fields of the object are assigned an initial value from the array at least prior to the object being accessible in the runtime environment.

When the system determines that the verification process indicates that, when an object representing an instance of the class is initialized, one or more instance fields of the object are assigned an initial value from the array, the system loads the class in the runtime environment (Operation 848). Upon having loaded the class in the runtime environment, the system initializes object representing an instance of the class with one or more instance fields of the object being assigned an initial value from the array (Operation 850). Additionally or alternatively, when the system determines that the verification process indicates that, when an object representing an instance of the class is initialized, one or more instance fields of the object are not assigned an initial value from the array, the system initializes execution of an error handling process (Operation 852). The error handling process may include refraining from loading the class in the runtime environment. Additionally or alternatively, the error handling process may include generating an exception and directing the exception to an exception handler for processing. Additionally or alternatively, the error handling process may include obtaining initial values for the array.

Referring to FIG. 8D, the system accesses a static field of a class that is configured to be assigned an initial value from an array. As shown in FIG. 8D, the system encounters a static field-access instruction to access a static field of a class that has yet to be accessed (Operation 860). In response to the static field-access instruction, the system determines whether the static field configured to be assigned an initial value from an array (Operation 862). The system may determine whether a static field is to be initialized with an initial value from an array based on a declaration for the static field. The system may analyze the static field through code inspection, reflection, or by reading configuration files or annotations.

When the system determines that the static field is configured to be assigned an initial value from an array, the system executes a verification process to verify that an initial value has been assigned to the static field from the array (Operation 864). The verification process may include verifying that, elements of the array are initialized with initial values, for example, as described with reference to FIG. 8A and/or FIG. 8B. Additionally or alternatively, the verification process may include a verification process as described with reference to FIGS. 7A-7C.

The system determines whether the verification process indicates that the initial value has been assigned to the static field from the array (Operation 866). In one example, the system determines that the static field has been assigned an initial value from the array based on having determined that elements of the array are initialized with initial values. Additionally or alternatively, the system may determine, based on an analysis of a bitset of the static field, that the static field has been assigned an initial value from the array.

When the system determines that the initial value has been assigned to the static field from the array, the system accesses the static field in response to the static field-access instruction (Operation 868). When the system determines that the initial value has not been assigned to the static field from the array, the system initiates execution of an error handling process (Operation 870). The error handling process may include refraining from initializing the class. Additionally or alternatively, the error handling process may include generating an exception and directing the exception to an exception handler for processing. Additionally or alternatively, the error handling process may include an initial value for the array and populating the static field with the initial value.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

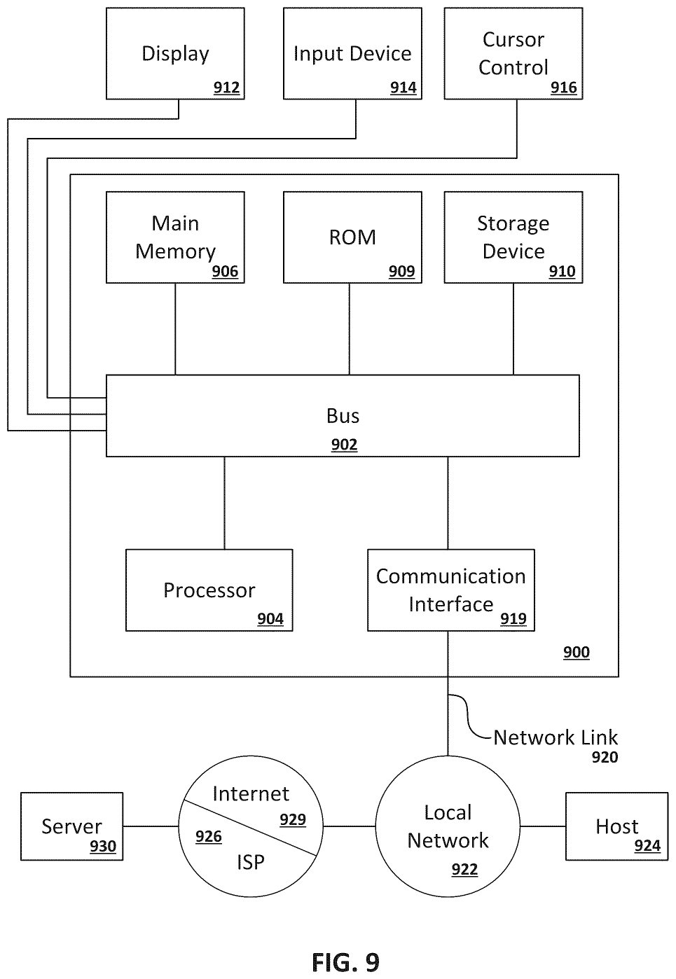

For example, FIG. 9 is a block diagram that illustrates a computer system 900 that may be utilized to implement at least one embodiment of the present disclosure. Computer system 900 may include a bus 902 or other communication mechanism for communicating information, and a hardware processor 904 coupled with bus 902 for processing information. Hardware processor 904 may be, for example, a general-purpose microprocessor.

Computer system 900 also may include a main memory 906, such as a random-access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 may further include a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware, and/or program logic that, in combination with the computer system, causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media may include, for example, optical or magnetic disks, such as storage device 910. Volatile media may include dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media may include coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906. Processor 904 retrieves the data from main memory 906 and executes the instructions. The instructions received from main memory 906 may optionally be stored on storage device 910 either before or after execution by processor 904.

Computer system 900 also may include a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world-wide packet data communication network now commonly referred to as the “Internet” 928. Local network 922 and Internet 928 both use electrical, electromagnetic, or optical signals that carry digital data streams. Example forms of transmission media include the signals through the various networks, the signals through network link 920, and the signals through communication interface 918.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, and/or stored in storage device 910, or other non-volatile storage for later execution.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form that such claims issue, including any subsequent correction.

What is claimed is:

1. A method, comprising:
encountering, while executing a first bytecode segment in a runtime environment, a first instruction that triggers generating an array comprising a set of elements initialized with a set of initial values;
responsive to encountering the first instruction:
identifying an application programming interface (API) for generating the array;
executing a call to the API to request the API to generate the array,
wherein the API receives the call and, in response to the call, executes an array generation process to generate the array;
receiving, from the API in response to the call to the API, the array comprising the set of elements initialized with the set of initial values;
wherein the method is performed by at least one device including a hardware processor.

2. The method of claim 1, further comprising:
providing the array from the API to the runtime environment,
wherein the API comprises a constraint that requires the set of elements to be initialized with the set of initial values prior to providing the array to the runtime environment.

3. The method of claim 1, wherein prior to providing the array to the runtime environment, the API executes a verification process to verify that the set of elements are initialized with the set of initial values.

4. The method of claim 1, further comprising:
subsequent to receiving the array from the API, executing a verification process to verify that the set of elements are initialized with the set of initial values.

5. The method of claim 1, wherein the array generation process comprises:
determining a quantity of elements for the set of elements of the array;
generating the set of elements of the array in accordance with the quantity of elements;
determining the set of initial values for initializing the set of elements with the set of initial values;
populating the set of elements with the set of initial values.

6. The method of claim 5, wherein determining the quantity of elements for the set of elements of the array comprises:
accessing a data repository, and
determining the quantity of elements based on a quantity of elements in the data repository.

7. The method of claim 5,
wherein determining the set of initial values comprises:
accessing a data repository comprising the set of initial values, and
identifying the set of initial values in the data repository; and
wherein populating the set of elements with the set of initial values comprises;
populating the set of elements with the set of initial values identified in the data repository.

8. The method of claim 5, wherein determining the quantity of elements for the set of elements of the array comprises:
identifying a function for determining the quantity of elements;
executing the function to determine the quantity of elements.

9. The method of claim 5, wherein determining the set of initial values comprises:
identifying a function for determining the set of initial values;
executing the function to determine the set of initial values.

10. The method of claim 1,
wherein the call comprises:
an element quantity package for the API to determine a quantity of elements for the set of elements of the array, and
wherein the array generation process comprises:
determining a quantity of elements for the set of elements of the array based on the element quantity package.

11. The method of claim 10, wherein the element quantity package comprises the quantity of elements.

12. The method of claim 10, wherein the element quantity package comprises or identifies a function for determining the quantity of elements.

13. The method of claim 1,
wherein the call comprises:
an initial value package for the API to determine the initial values for initializing the set of elements with the set of initial values;
wherein the array generation process comprises:
determining the set of initial values for initializing the set of elements with the set of initial values based on the initial value package.

14. The method of claim 13, wherein the initial value package comprises the set of initial values.

15. The method of claim 13, wherein the initial value package comprises or identifies a function for determining the set of initial values.

16. The method of claim 1, further executing the first bytecode segment, wherein further executing the first bytecode segment comprises:
encountering a first instruction that triggers loading a first class for initializing a first object comprising a first instance field to be initialized with a first initial value from the array, wherein the first object represents a first instance of the first class;
responsive to encountering the first instruction, verifying that when the first object is initialized, the first instance field is assigned the first initial value from the array;
responsive at least in part to verifying that when the first object is initialized, the first instance field is assigned the first initial value from the array:
loading the first class in the runtime environment, wherein loading the first class in the runtime environment is contingent upon verifying that when the first object is initialized, the first instance field is assigned the first initial value from the array.

17. The method of claim 1, further executing the first bytecode segment, wherein further executing the first bytecode segment comprises:
encountering a static field-access instruction to access a static field that is configured to be assigned an initial value from the array, wherein the static field has yet to be accessed;
responsive to encountering the static field-access instruction:
determining that the initial value has been assigned to the static field from the array;
responsive to determining that the initial value has been assigned to the static field from the array: accessing the static field, wherein accessing the static field is contingent upon determining that the initial value has been assigned to the static field from the array.

18. The method of claim 1, wherein the set of initial values, of the set of elements of the array, comprises at least one of: a set of classes, or a set of static fields.

19. One or more non-transitory computer-readable media storing instructions that, when executed by one or more hardware processors, cause performance of operations comprising:
encountering, while executing a first bytecode segment in a runtime environment, a first instruction that triggers generating an array comprising a set of elements initialized with a set of initial values;
responsive to encountering the first instruction:
identifying an application programming interface (API) for generating the array;
executing a call to the API to request the API to generate the array,
wherein the API receives the call and, in response to the call, executes an array generation process to generate the array;
receiving, from the API in response to the call to the API, the array comprising the set of elements initialized with the set of initial values.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
encountering, while executing a first bytecode segment in a runtime environment, a first instruction that triggers generating an array comprising a set of elements initialized with a set of initial values;
responsive to encountering the first instruction:
identifying an application programming interface (API) for generating the array;
executing a call to the API to request the API to generate the array,
wherein the API receives the call and, in response to the call, executes an array generation process to generate the array;
receiving, from the API in response to the call to the API, the array comprising the set of elements initialized with the set of initial values.
